(19) United States
(12) Patent Application Publication
(10) Pub. No.: US 2022/0315757 A1
(43) Pub. Date: Oct. 6, 2022

(54) LOW TVOC FLAME-RETARDANT POLYURETHANE SPRAY FOAM SYSTEM

(71) Applicant: BASF SE, Ludwigshafen am Rhein (DE)

(72) Inventors: He Meng Zhao, Shanghai (CN); Wei Yang, Shanghai (CN); Chao Wang, Shanghai (CN)

(21) Appl. No.: 17/628,685

(22) PCT Filed: Jun. 29, 2020
(86) PCT No.: PCT/EP2020/068281

§ 371 Date: Jan. 20, 2022

(30) Foreign Application Priority Data
Jul. 22, 2019 (CN) PCT/CN2019/097107

(51) Int. Cl. C08L 75/04; C08L 67/08; C08J 9/12; C08J 9/228

(52) U.S. Cl. CPC C08L 75/04; C08L 67/08; C08J 9/125; C08J 9/228; C08L 2201/02; C08L 2205/05; C08J 2201/022; C08J 2207/04; C08J 2375/04

(57) ABSTRACT

Described herein is a Low TVOC flame-retardant polyurethane spray foam system, including at least one isocyanate as isocyanate component, and at least one substance reactive toward isocyanate, chain extender and/or crosslinking agent, flame retardant, blowing agent, catalysts, and additives and/or auxiliaries, as resin components, where the flame retardant includes expandable graphite and melamine, the amount of expandable graphite is in the range of from 5 wt % to less than 30 wt %, and the amount of melamine is in the range of from greater than 5 wt % to 30 wt %, each based on the total weight of the resin components. Also described herein are a polyurethane spray foam produced therefrom, the preparation thereof, and a method of use thereof in the application of heat insulation, sound insulation, cavity filling and damping packing.

### TECHNICAL FIELD

The present invention relates to flame-retardant polyurethane spray foam system, in particular to Low TVOC flame-retardant polyurethane spray foam system, to the polyurethane spray foam produced therefrom, and to the preparation thereof, and to the use of the polyurethane foam in the application of heat insulation, sound insulation, such as in transportation or construction field, or in cavity filling (sponge) and damping packing foam application.

### BACKGROUND

Polyurethane foams are suitable for a large number of applications, for example cushioning materials, thermal insulation materials, packaging, automobile-dashboards, or construction materials. Many of these applications require effective flame retardancy. A very wide variety of flame retardants have therefore previously been described for polyurethanes.

Halogenated compounds are used by way of example as flame retardants. Halogenated flame retardants, however, in particular brominated flame retardants, are undesirable for toxicological, environmental, and regulatory reasons. Furthermore, halogenated flame retardants also cause increased smoke density in the event of fire, and can decompose to gaseous halogen-containing compounds such as HCl or HBr.

Phosphorus-containing compounds, especially organophosphorus compounds, are widely used flame retardants. Organophosphorus flame retardants are mostly based on phosphate esters, phosphonate esters, or phosphite esters. Known phosphorus-containing flame retardants, such as triethyl phosphate (TEP) or diethyl ethanephosphonate (DEEP), contribute by way of example to emissions from plastics, thus giving these an unpleasant odor. This hinders the use of said flame retardants in the production of polyurethane foams intended for use in enclosed spaces, for example in the passenger compartment of an automobile.

According to new transportation industry standard JT-1095 in China, the fire performance of insulation foam for commercial bus is defined. The required oxygen index of the foam is much higher than before. Up till now, most spray foams for bus are based on the above-mentioned liquid flame retardants, which tend to migrate and volatilize from the foam, resulting in very high TVOC (Total Volatile Organic Compounds) values. It is desired to prepare spray foam with low TVOC value.

The use of solid flame retardants has also been proposed. For example, U.S. Pat. No. 6,552,098B describes open-celled flame-retardant polyurethane foam comprising, as flame retardants, exfoliating graphite and optionally other known flame-retardant ingredients, such as halogen- and/or phosphorous-containing compounds, antimony oxides, boron-containing compounds, hydrated aluminas or polyammonium phosphates.

U.S. Pat. No. 4,221,875A describes rigid polyurethane foams comprising melamine powder as flame retardant in an amount between 20 and 100 parts by weight based on the weight of the polyhydroxyl compound.

However, these documents do not disclose the combination of expandable graphite and melamine.

U.S. Pat. No. 5,023,280A describes a process for the production of polyurethane foams comprising, as flame-retardants, the combinations of graphite and co-flame-retardants, such as ammonium polyphosphates, oligophosphates, calcium cyanamide, lime, aluminum oxides, aluminum hydrates, aluminum hydroxides, boron oxides, urea, melamine, melamine derivatives, melamine salts, cyanamide and dicyandiamide, wherein the amount of graphite is from 1 to 30 parts by weight, preferably 1 to 20 parts by weight and most preferably 2.5 to 15 parts by weight, and the amount of co-flame-retardant is from 1 to 30 parts by weight, preferably from 1 to 25 parts by weight and most preferably from 2.5 to 20 parts by weight, based on substance reactive toward isocyanate 2). But the example does not include melamine.

U.S. Pat. No. 5,192,811A describes a process for preparing a flame-resistant, elastic soft polyurethane foam comprising the combination of expandable graphite and melamine in a ratio of from 1:3 to 2:3, the total amount of expandable graphite and melamine is from 20 to 40% by weight of reaction mixture. The polyurethane foam has a high density of from 40 to 200 kg/m³. The above two patents relate to common foaming process using only solid flame-retardant, and fail to disclose or suggest any spray-in-place foam system.

When solid flame retardants are used in spray-in-place foam system to produce an open-celled polyurethane foam for use in bus insulation or construction insulation, one problem encountered in spray foam systems is insufficient mixing, and thus inefficient processing. The prior art documents do not mention spray processing problem encountered by spray foam system comprising solid flame retardant.

Therefore, it is still required to provide a flame-retardant polyurethane spray foam system that shows successful spray processing and, at the same time, lower TVOC value.

### SUMMARY OF THE PRESENT INVENTION

An object of this invention is to overcome the problems of the prior art discussed above and to provide a flame-retardant polyurethane spray foam system that shows successful spray processing and, at the same time, TVOC value lower than 220 μg C/g.

Surprisingly, it has been found by the inventors that the above object can be achieved by a flame-retardant polyurethane spray foam system, comprising isocyanate component consisting of

a) at least one isocyanate, and

resin components consisting of

b) at least one substance reactive toward isocyanate,

c) optionally chain extender and/or crosslinking agent,

d) flame retardant,

e) blowing agent,

f) catalysts, and

g) optionally additives and/or auxiliaries,

wherein the flame retardant (d) comprises expandable graphite and melamine, the amount of expandable graphite is in the range of from 5 wt % to less than 30 wt %, and the amount of melamine is in the range of from greater than 5 wt % to 30 wt %, each based on the total weight of the resin components.

In a preferred embodiment, the amount of expandable graphite is in the range of 10 to 25 wt %, preferably 10 to 20 wt %, more preferably 15 to 20 wt %, based on the total weight of the resin components.

In a preferred embodiment, the amount of melamine is in the range of 10 to 25 wt %, preferably 15 to 25 wt %, more preferably 15 to 20 wt %, based on the total weight of the resin components.

In a more preferred embodiment, the total amount of graphite and melamine is in the range of 10 to 40 wt %, preferably 20 to 35 wt %, more preferably 30 to 35 wt %, based on the total weight of the resin components.

In a still preferred embodiment, the flame retardant (d) further comprises at least one phosphorus-containing flame retardant which is a derivative of phosphoric acid, phosphonic acid, and/or phosphinic acid.

In another preferred embodiment, the amount of said phosphorus-containing flame retardant is in the range of 10 to 40 wt %, preferably 10 to 35 wt %, based on the total weight of the resin components.

In another preferred embodiment, the weight ratio of resin components and isocyanate component is in a range of from 1:0.8 to 1:1.2, preferably from 1:0.9 to 1:1.2, more preferably from 1:1 to 1:1.2.

In another preferred embodiment, the spray foam system of the invention produces polyurethane foam with a density between 10 and 40 kg/m³, preferably between 15 and 30 kg/m³, more preferably between 16 and 27 kg/m³.

In a further aspect, the invention relates to a method for the production of flame-retardant polyurethane foam from the polyurethane spray foam system according to the invention, comprising the following steps:
providing a polyol blend comprising the components (b)-(g);
providing isocyanate component (a); and
reacting the polyol blend and the isocyanate component (a) in a weight ratio of 1:0.8 to 1:1.2, preferably 1:0.9 to 1:1.2, more preferably 1:1 to 1:1.2.

In a further aspect, the invention relates to a flame-retardant polyurethane foam produced according to the invention.

In a further aspect, the invention relates to the use of the flame-retardant polyurethane foam according to the invention in the application of heat insulation, sound insulation, such as in transportation or construction field, or in cavity filling (sponge) and damping packing foam application.

It has been surprisingly found in this application that, by adding expandable graphite and melamine in specific amounts into polyurethane spray foam system, the polyurethane spray foam system shows successful spray processing and, at the same time, lower TVOC value.

### DETAILED DESCRIPTION OF THE PRESENT INVENTION

Unless defined otherwise, all technical and scientific terms used herein have the meaning commonly understood by a person skilled in the art to which the invention belongs. As used herein, the following terms have the meanings ascribed to them below, unless specified otherwise.

As used herein, the articles “a” and “an” refer to one or to more than one (i.e., to at least one) of the grammatical object of the article. By way of example, “an element” means one element or more than one element.

Unless otherwise identified, all percentages (%) are “percent by weight”.

Unless otherwise identified, the temperature refers to room temperature and the pressure refers to ambient pressure.

Unless otherwise identified, the solvent refers to all organic and inorganic solvents known to the persons skilled in the art and does not include any type of monomer molecular.

In one aspect, the present invention provides a flame-retardant polyurethane spray foam system, comprising isocyanate component consisting of

a) at least one isocyanate, and

resin components consisting of

b) at least one substance reactive toward isocyanate,

c) optionally chain extender and/or crosslinking agent,

d) flame retardant,

e) blowing agent,

f) catalysts, and optionally

g) additives and/or auxiliaries,

wherein the flame retardant (d) comprises expandable graphite and melamine, the amount of expandable graphite is in the range of from 5 wt % to less than 30 wt %, and the amount of melamine is in the range of from greater than 5 wt % to 30 wt %, each based on the total weight of the resin components.

The spray foam system of the invention is typically referred to as a spray-in-place foam system. These systems are sprayed as two components in liquid form into a desired space. After spraying, the components begin to rise, cream, and gel forming the polyurethane foam. It is to be appreciated that the components may begin to react as they are sprayed. The spray system produces the polyurethane foam of the invention having a density between 10 and 40 kg/m³, preferably between 15 and 30 kg/m³, more preferably between 16 and 27 kg/m³. The low density polyurethane foam is kind of light-weight and energy-saving material, while a desired insulation value can be achieved.

Isocyanate Component (a)

Isocyanates (a) used for producing the polyurethanes of the invention comprise all isocyanates known for producing polyurethanes. These comprise aliphatic, cycloaliphatic, araliphatic and/or aromatic isocyanates, such as tri-, tetra-, penta-, hexa-, hepta- and/or octamethylene diisocyanate, 2-methylpentamethylene 1,5-diisocyanate, 2-ethylbutylene 1,4-diisocyanate, pentamethylene 1,5-diisocyanate, butylene 1,4-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), cyclohexane 1,4-diisocyanate, 1-methylcyclohexane 2,4- and/or 2,6-diisocyanate and/or dicyclohexylmethane 4,4′-, 2,4′- and 2,2′-diisocyanate, diphenylmethane 2,2′-, 2,4′- and/or 4,4′-diisocyanate (MDI), polymeric MDI, naphthylene 1,5-diisocyanate (NDI), tolylene 2,4- and/or 2,6-diisocyanate (TDI), 3,3′-dimethyl diphenyl diisocyanate, 1,2-diphenylethane diisocyanate and/or phenylene diisocyanate. Particular preference is given to using 2,2′-, 2,4′- and/or 4,4′-diisocyanate, and polymeric MDI.

Other possible isocyanates are given by way of example in “Kunststoffhandbuch, Band 7, Polyurethane” [Plastics handbook, volume 7, Polyurethanes], Carl Hanser Verlag, 3rd edition, 1993, chapters 3.2 and 3.3.2.

Component (b)

Substance reactive toward isocyanate (b) can be any of the compounds used for polyurethane production in the art and having at least two reactive hydrogen atoms. By way of example, it is possible to use polyether polyamines and/or polyols selected from the group of the polyether polyols and polyester polyols, or a mixture thereof.

The polyols preferably used are polyether polyols with a molecular weight between 500 and 6000, preferably from 2000 to 5000, more preferably from 2500 to 3500, OH value between 20 and 200 mg KOH/g, preferably from 30 to 100 mg KOH/g, and/or polyester polyols with molecular weights between 350 and 2000, preferably from 350 to 650, OH value between 60 and 650 mg KOH/g, preferably from 120 to 310 mg KOH/g. The following polyols are preferred in the invention: LUPRANOL® 2095 (BASF), LUPRANOL® 2090 (BASF), LUPRAPHEN® 3905 (BASF), LUPRAPHEN® 3907 (BASF), LUPRAPHEN® 3909 (BASF), STEPANPOL® PS 3152, PS 2412, PS 1752, CF 6925 (Stepan Company).

The polyether polyols that can be used in the invention are produced by known processes. By way of example, they can be produced from one or more alkylene oxides having from 2 to 4 carbon atoms in the alkylene radical via anionic polymerization using alkali metal hydroxides, such as sodium hydroxide or potassium hydroxide, or using alkali metal alcoholates, such as sodium methoxide, sodium ethoxide or potassium ethoxide, or potassium propoxide as catalysts, with addition of at least one starter molecule which comprises from 2 to 8 reactive hydrogen atoms, or via cationic polymerization using Lewis acids, such as antimony pentachloride, boron fluoride etherate, etc., or bleaching earth as catalysts.

Examples of suitable alkylene oxides are tetrahydrofuran, propylene 1,2-oxide, butylene 1,2-oxide or butylene 2,3-oxide, styrene oxide, and preferably ethylene oxide and propylene 1,2-oxide. The alkylene oxides can be used individually, in alternating succession, or as a mixture.

Examples of starter molecules that can be used are: water, organic dicarboxylic acids, such as succinic acid, adipic acid, phthalic acid, and terephthalic acid, aliphatic and aromatic, optionally N-mono-, N,N-, and N,N′-dialkyl-substituted diamines having from 1 to 4 carbon atoms in the alkyl radical, e.g. optionally mono- and dialkyl-substituted ethylenediamine, diethylenetriamine, triethylenetetramine, 1,3-propylenediamine, 1,3- or 1,4-butylenediamine, 1,2-, 1,3-, 1,4-, 1,5-, and 1,6-hexamethylenediamine, phenylenediamines, 2,3-, 2,4-, and 2,6-tolylenediamine, and 4,4′-, 2,4′-, and 2,2′-diaminodiphenylmethane.

Polyester polyols can by way of example be produced from dicarboxylic acids having from 2 to 12 carbon atoms, preferably from 4 to 6 carbon atoms, and from polyhydric alcohols. Examples of dicarboxylic acids that can be used are: aliphatic dicarboxylic acids, such as succinic acid, glutaric acid, adipic acid, suberic acid, azelaic acid, and sebacic acid, and aromatic dicarboxylic acids, such as phthalic acid, isophthalic acid, and terephthalic acid. The dicarboxylic acids can be used individually or in the form of mixtures, e.g. in the form of a mixture of succinic, glutaric, and adipic acid. Examples of polyhydric alcohols are glycols having from 2 to 10, preferably from 2 to 6, carbon atoms, e.g. ethylene glycol, diethylene glycol, 1,4-butanediol, 1,5-pentanediol, 1,6-hexanediol, 1,10-decanediol, 2,2-dimethyl-1,3-propanediol, 1,3-propanediol, and dipropylene glycol, triols having from 3 to 6 carbon atoms, e.g. glycerol and trimethylolpropane, and, as higher-functionality alcohol, pentaerythritol. The polyhydric alcohols can be used alone or optionally in mixtures with one another, in accordance with the properties desired.

The amount of polyether polyol and/or polyester polyol, based on the total weight of the resin components, is preferably from 0 to 40% by weight, particularly preferably from 15 to 35% by weight, and in particular from 15 to 20% by weight.

Chain Extender and/or Crosslinking Agent (c)

Chain extenders and/or crosslinking agents (c) that can be used are substances having a molar mass which is preferably smaller than 500 g/mol, particularly preferably from 60 to 400 g/mol, wherein chain extenders have 2 hydrogen atoms reactive toward isocyanates and crosslinking agents have 3 hydrogen atoms reactive toward isocyanate. These can be used individually or preferably in the form of a mixture. It is preferable to use diols and/or triols having molecular weights smaller than 500, particularly from 60 to 400, and in particular from 60 to 350. Examples of those that can be used are aliphatic, cycloaliphatic, and/or araliphatic diols having from 2 to 14, preferably from 2 to 10, carbon atoms, e.g. ethylene glycol, 1,3-propanediol, 1,4-butanediol, 1,6-hexanediol, 1,10-decanediol, 1,2-, 1,3-, and 1,4-dihydroxycyclohexane, diethylene glycol, dipropylene glycol, tripropylene glycol, diethanolamine, or triols, e.g. 1,2,4- or 1,3,5-trihydroxycyclohexane, glycerol, and trimethylolpropane.

The amount of chain extender and/or crosslinking agent c), if present, is preferably from 0 to 20% by weight, particularly preferably from 10 to 15% by weight, based on the total weight of the resin components.

Flame Retardant (d)

Flame retardants (d) used are flame retardants which comprise melamine and expandable graphite (EG) as solid flame retardant.

Expandable graphite is well known in the art. Expandable graphite is a synthesized intercalation compound of graphite that expands or exfoliates when heated. This material is manufactured by treating flake graphite with various intercalation reagents that migrate between the graphene layers in a graphite crystal and remain as stable species. If exposed to a rapid increase in temperature, these intercalation compounds decompose into gaseous products, which results in high inter-graphene layer pressure. This pressure develops enough force to push apart graphite basal planes in the “c” axis direction. The result is an increase in the volume of the graphite of up to 300 times, a lowering of bulk density, and approximately a 10-fold increase in surface area. The expandable graphite used may have a particle size of from 50 to 200 mesh, preferably from 80 to 100 mesh.

The amount of the expandable graphite used in the invention is usually in the range of from 5% by weight to less than 30% by weight, based on the total weight of the resin components. It is preferable to use from 10 to 25% by weight of expandable graphite, particularly preferably from 10 to 20% by weight of expandable graphite, more preferably from 15 to 20% by weight of expandable graphite, based on the total weight of the resin components.

The amount of the melamine used in the invention is usually in the range of from greater than 5% by weight to 30% by weight, based on the total weight of the resin components. It is preferable to use from 10 to 25% by weight of melamine, particularly preferably from 15 to 25% by weight of melamine, more preferably from 15 to 20% by weight of melamine, based on the total weight of the resin components.

If the respective amount of expandable graphite and melamine is outside the range as mentioned above, the spray processing will fail.

For the purpose of balance between TVOC value and spray processing, the total amount of solid flame retardants is preferably in the range of 10 to 40 wt %, more preferably 20 to 35 wt %, most preferably 30 to 35 wt %, based on the total weight of the resin components. If the amount is lower than 10 wt %, the TVOC value will be too high and thus not environmentally friendly, and if the amount is higher than 40 wt %, the spray processing will fail.

The flame retardant (d) can further comprise liquid flame retardant, such as halogen-containing flame retardant, phosphorus-containing flame retardant. As liquid flame retardant, it is preferable to use tris(1-chloro-2-propyl) phosphate (TCPP), triethyl phosphate (TEP) and Saytex RB-79 (bromine-containing diester/ether diol of tetrabromophthalic anhydride from ALBEMARLE Corporation). The amount of liquid flame retardant is in the range of 10 to 40 wt %, preferably 10 to 35 wt %, based on the total weight of the resin components.

Blowing Agent (e)

The blowing agent (e) used according to the invention preferably comprises water. The blowing agent (e) used can also comprise, as well as water, other chemical and/or physical blowing agents in the art. Chemical blowing agents are compounds which form gaseous products through reaction with isocyanate, an example being water or formic acid. Physical blowing agents are compounds which have been dissolved or emulsified in the starting materials for polyurethane production and which vaporize under the conditions of polyurethane formation. By way of example, these are hydrocarbons, halogenated hydrocarbons, and other compounds, such as perfluorinated alkanes, e.g. perfluorohexane, fluorochlorocarbons, and ethers, esters, ketones and/or acetals. In one preferred embodiment, water is used as sole blowing agent (e). In this case, the polyurethane foam according to the invention is water-blown polyurethane spray foam. Concerning water, there is no particular limitation. Mineral water, deionized water or tapwater can be used.

The amount of blowing agent is from 2 to 15% by weight, preferably from 5 to 10% by weight, based on the total weight of the resin components.

Catalyst (f)

As catalyst (f), it is possible to use all compounds which accelerate the isocyanate-polyol reaction. Such compounds are known and are described, for example, in “Kunststoffhandbuch, volume 7, Polyurethane”, Carl Hanser Verlag, 3rd edition 1993, chapter 3.4.1. These comprise amine-based catalysts and catalysts based on organic metal compounds.

As catalysts based on organic metal compounds, it is possible to use, for example, organic tin compounds such as tin(II) salts of organic carboxylic acids, e.g. tin(II) acetate, tin(II) octoate, tin(II) ethylhexanoate and tin(II) laurate, and the dialkyltin(IV) salts of organic carboxylic acids, e.g. dibutyltin diacetate, dibutyltin dilaurate, dibutyltin maleate and dioctyltin diacetate, and also bismuth carboxylates, e.g. bismuth(III) neodecanoate, bismuth 2-ethylhexanoate and bismuth octanoate, or alkali metal salts of carboxylic acids, e.g. potassium acetate or potassium formate.

Preference is given to using amine-based catalysts as catalyst (f), such as N,N,N′,N′-tetramethyldipropylenetriamine, 2-[2-(dimethylamino)ethyl-methylamino]ethanol, N,N,N′-trimethyl-N′-2-hydroxyethyl-bis-(aminoethyl)ether, bis(2-dimethylaminoethyl) ether, N,N,N,N,N-pentamethyldiethylenetriamine, N,N,N-triethylaminoethoxyethanol, dimethylcyclohexylamine, trimethyl hydroxyethyl ethylenediamine, dimethylbenzylamine, triethylamine, triethylenediamine, pentamethyldipropylenetriamine, dimethylethanolamine, N-methylimidazole, N-ethylimidazole, tetramethylhexamethylenediamine, tris(dimethylaminopropyl)hexahydrotriazine, dimethylaminopropylamine, N-ethylmorpholine, diazabicycloundecene and diazabicyclononene. Here, examples which may be mentioned are Jeffcat ZF10 (CAS No. 83016-70-0), Jeffcat DM EA (CAS No. 108-01-0) and Dabco T (CAS No. 2212-32-0). This kind of reactive catalyst has an effect of reducing VOC value.

The amount of catalyst (f), based on the total weight of the resin components, is preferably from 1 to 5% by weight, particularly preferably from 1.5 to 3.5% by weight.

Additives and/or Auxiliaries (g)

Additives and/or auxiliaries (g) that can be used comprise surfactants, cell opener, preservatives, colorants, antioxidants, reinforcing agents, stabilizers and fillers. In preparing polyurethane foam, it is generally highly preferred to employ a minor amount of a surfactant to stabilize the foaming reaction mixture until it cures. Such surfactants advantageously comprise a liquid or solid organosilicone surfactant, which is employed in amounts sufficient to stabilize the foaming reaction mixture. Typically, the amount of auxiliaries, especially surfactants, is preferably from 0 to 2% by weight, more preferably from 0.5 to 2% by weight, most preferably from 0.6 to 1% by weight, based on the total weight of the resin components.

Further information concerning the mode of use and of action of the abovementioned auxiliaries and additives, and also further examples, are given by way of example in “Kunststoffhandbuch, Band 7, Polyurethane” [“Plastics handbook, volume 7, Polyurethanes”], Carl Hanser Verlag, 3rd edition 1993, chapter 3.4.

In another aspect, the present invention further provides a method for the production of flame-retardant polyurethane foam from the polyurethane spray foam system according to the invention, comprising the following steps:
providing a resin component blend comprising components (b)-(g),
providing isocyanate component (a); and
reacting the resin component blend and isocyanate component (a) in a weight ratio of 1:0.8 to 1:1.2, preferably 1:0.9 to 1:1.2, more preferably 1:1 to 1:1.2.

In preparing a polyurethane foam, it has been proven advantageous to use 2-component process and to use, as what is known as resin components, a mixture from the mixing of the substance reactive toward isocyanate (b), optionally chain extenders and/or crosslinking agents (c), flame retardants (d), blowing agents (e), catalysts (f), and optionally auxiliaries and additives (g), and to use, as what is known as isocyanate component, isocyanates (a).

As used herein, the step of reacting resin components and isocyanate component is defined as spraying resin components and isocyanate component, preferably defined as mixing resin components and isocyanate component through a nozzle of a spray gun.

The spray foam system may be sprayed with any typical two-component spraying equipment, which includes a two-component spray gun, as is known to those skilled in the art. One type of spraying equipment capable of use with a two-component system is shown in U.S. Pat. No. 6,527,203. The two components are typically mixed once they enter and exit a nozzle of the spray gun. The system must be able to spray the components at the specified ratios. Once the two components are mixed, the polyurethane foam begins to form.

The present invention provides a flame-retardant polyurethane foam produced according to the invention.

The polyurethane foam obtained by the present invention has a foam density between 16 and 27 Kg/m³, measured according to GB/T 6343-2008, LOI value of at least 26%, preferably at least 27%, and more preferably at least 27.2%, measured according to GB/T 2406.2-2009, TVOC of at most 220 μg C/g, preferably at most 180 μg C/g, and more preferably at most 130 μg C/g, measured according to VDA 277, tensile strength between 40 and 55 KPa, measured according to GB/T 6344-2008, volume percentage of closed cells of less than 10%, measured according to DIN ISO 4590-2003, flammability ratings of A-0, measured according to G 8410-2006.

The present invention further provides use of the flame-retardant polyurethane foam according to the invention in the application of heat insulation, sound insulation, such as in transportation or construction field, or in cavity filling (sponge) and damping packing foam application.

### EXAMPLE

The present invention will now be described with reference to Examples and Comparative Examples, which are not intended to limit the present invention.

The following starting materials were used:
Isocyanate:

PMDI, commercially available under trade name ISOCYANATE B1001 from BASF
Polyether polyol:

high reactive trifunctional polyether polyol containing primary hydroxyl, commercially available under trade name LUPRANOL® 2095 from BASF, OH number: 28˜35 mg KOH/g; Molecular weight: 3000˜6000
Polyester polyol:

aromatic polyester polyol, commercially available under trade name LUPRAPHEN 3905 from BASF, OH number: 175-310 mg KOH/g; Molecular weight: 350-650
Solid flame retardant:

melamine (CAS No:108-78-1), available from JIANGSU GOLDEN ELEPHANT SINCERITY CHEMICAL Co., Ltd expandable graphite (EG) from Sigma-Aldrich, 80 mesh
liquid flame retardant:

tris(1-chloro-2-propyl) phosphate (TCPP), CAS No: 13674-84-5, commercially available from Albright and Wilson Ltd.
Surfactant:

silicone surfactant commercially available as ORTEGOL 501 from Evonik,

silicone surfactant commercially available as TEGOSTAB® B 1048 from Evonik
Catalyst,

amine catalyst, CAS No: 83016-70-0, commercially available under trade name JEFFCAT ZF10 from Huntsman
Blowing agent: Deionized water
Chain extender: Dipropylene glycol (DPG)

The following methods were used to determine properties:

| | |
|---|---|
| Density in kg/m³: | GB/T 6343-2008 |
| LOI in % | GB/T 2406.2-2009 |
| Flammability | G 8410-2006 |
| TVOC in μgC/g | VDA 277 |
| Tensile strength in kPa: | GB/T 6344-2008 |
| Volume percentage of closed cells in % | DIN ISO 4590-2003 |

The spray processing:

Spray Machine: GRACO H-25 fixed mix ratio 1:1

Spray gun: GRACO AP Fusion with mix chamber sizes 4242

Spray temperature: 60° C. (Resin/ISO/pipe)

spray pressure: 1000 psi

spray distance: 60˜80 cm

Spray Foam is created by mixing the RESIN-side and ISO-side in the spray Gun.

Pass means: materials are mixed sufficiently, and the fluids spray is of round pattern having a diameter of about 20˜40 cm

Fail means: materials are mixed insufficiently, and the diameter of the round pattern is below 20 cm, or the fluids spray is linear, or the fluids cannot spray.

### Example 1

A polyol blend was prepared by mixing the following materials for 1 minutes at 1800 rpm in a beaker: 20 g LUPRANOL 2095, 15 g LUPRAPHEN 3905, 10 g TCPP, 0.3 g ORTEGOL 501, 0.7 g TEGOSTAB® B 1048, 10 g DPG, 3.0 g JEFFCAT ZF10, and 6 g water. Then, to the mixture was added 5 g expandable graphite, and the mixture was stirred for 3 minutes at 1800 rpm. 30 g melamine was then added to the above mixture, and stirred for 3 minutes at 1800 rpm. Finally, 120 g ISOCYANATE B1001 was added, and the mixture was stirred for 5 seconds at 1800 rpm. The foam was allowed to rise under free rise conditions.

### Example 2

A polyol blend was prepared by mixing the following materials for 1 minutes at 1800 rpm in a beaker: 20 g LUPRANOL 2095, 15 g LUPRAPHEN 3905, 10 g TCPP, 0.3 g ORTEGOL 501, 0.7 g TEGOSTAB® B 1048, 10 g DPG, 3.0 g JEFFCAT ZF10, and 6 g water. Then, to the mixture was added 10 g expandable graphite, and the mixture was stirred for 3 minutes at 1800 rpm. 25 g melamine was then added to the above mixture, and stirred for 3 minutes at 1800 rpm. Finally, 120 g ISOCYANATE B1001 was added, and the mixture was stirred for 5 seconds at 1800 rpm. The foam was allowed to rise under free rise conditions.

### Example 3

A polyol blend was prepared by mixing the following materials for 1 minutes at 1800 rpm in a beaker: 20 g LUPRANOL 2095, 15 g LUPRAPHEN 3905, 10 g TCPP, 0.3 g ORTEGOL 501, 0.7 g TEGOSTAB® B 1048, 10 g DPG, 3.0 g JEFFCAT ZF10, and 6 g water. Then, to the mixture was added 20 g expandable graphite, and the mixture was stirred for 3 minutes at 1800 rpm. 15 g melamine was then added to the above mixture, and stirred for 3 minutes at 1800 rpm. Finally, 120 g ISOCYANATE B1001 was added, and the mixture was stirred for 5 seconds at 1800 rpm. The foam was allowed to rise under free rise conditions.

### Comparative Example 1-4

All the procedures are repeated according to example 1 except that the amounts of expandable graphite, melamine, and tris(1-chloro-2-propyl) phosphate (TCPP) were altered as shown in the following Table 1.

a. Effect of the Contents of Solid Flame Retardant

The inventors tested the effect of the contents of solid flame retardant on polyurethane spray foam. Various comparative and inventive compositions were prepared according to the procedure stated above for Example 1, except that the amounts of expandable graphite, melamine, and tris(1-chloro-2-propyl) phosphate (TCPP) were altered as shown in the following Table 1.

The TVOC value, LOI (%), and spray processing were tested according to the methods stated above. The results were summarized in the following Table 1.

TABLE 1

| | Inventive | Inventive | Inventive | Comparative | Comparative | Comparative | Comparative |
|---|---|---|---|---|---|---|---|
| Example | example 1 | example 2 | example 3 | example 1 | example 2 | example 3 | example 4 |
| ISOCYANATE B1001 | 120 | 120 | 120 | 120 | 120 | 120 | 120 |
| Polyether polyol, LUPRANOL 2095 | 20 | 20 | 20 | 20 | 20 | 20 | 20 |
| Polyester polyol, LUPRAPHEN | 15 | 15 | 15 | 15 | 15 | 15 | 15 |
| 3905 | | | | | | | |
| Solid flame retardant, expandable | 5 | 10 | 20 | 30 | 35 | — | — |
| graphite | | | | | | | |
| Solid flame retardant, melamine | 30 | 25 | 15 | 5 | — | 35 | — |
| Liquid flame retardant, TCPP | 10 | 10 | 10 | 10 | 10 | 10 | 45 |
| Surfactant, ORTEGOL 501 | 0.3 | 0.3 | 0.3 | 0.3 | 0.3 | 0.3 | 0.3 |
| Surfactant, TEGOSTAB ® B 1048 | 0.7 | 0.7 | 0.7 | 0.7 | 0.7 | 0.7 | 0.7 |
| Catalyst, JEFFCAT ZF10 | 3.0 | 3.0 | 3.0 | 3.0 | 3.0 | 3.0 | 3.0 |
| Blowing agent, water | 6 | 6 | 6 | 6 | 6 | 6 | 6 |
| Chain extender, Dipropylene glycol | 10 | 10 | 10 | 10 | 10 | 10 | 10 |
| Foam density (kg/m³) | 25~27 | 25~27 | 25~27 | 25~27 | 25~27 | 25~27 | 25~27 |
| LOI (%) | 26.8 | 27.2 | 28.7 | 30 | 31 | 24.8 | 24.7 |
| Flammability | A-0 | A-0 | A-0 | A-0 | A-0 | A-0 | A-0 |
| TVOC (μgC/g) | 180 | 126 | 98.1 | 90 | 82.1 | 353.5 | 853.5 |
| Volume percentage of closed cells | <10 | <10 | <10 | <10 | <10 | <10 | <10 |
| (%) | | | | | | | |
| Spray processing | Pass | Pass | Pass | Fail | Fail | Fail | Pass |

It can be seen from the Table 1 that, Inventive examples 1-3, comprising solid flame retardants, show TVOC value below 200 μg C/g, whereas Comparative Example 4, comprising only liquid TCPP as flame retardant, shows TVOC value of 853.5 μg C/g, too high for automobile spraying application.

The inventors surprisingly found that Comparative Examples 2-3, comprising only expandable graphite or melamine as solid flame retardant, cannot pass spray processing. In contrast, Inventive examples 1-3, comprising a mixture of expandable graphite and melamine, successfully pass spray processing.

Moreover, Comparative Example 1, comprising 30% of expandable graphite and 5% of melamine, falling outside the range according to the invention, fails in spray processing. It is confirmed that for the purpose of passing spray processing, the amount of expandable graphite and melamine should be controlled within the claimed range.

In sum, the result proves that Inventive Examples comprising a mixture of expandable graphite and melamine in specific amounts according to the invention showed decreased TVOC value and at the same time successful spray processing. In contrast, Comparative Example 4, though pass spray processing as inventive examples, had a much higher TVOC value, while Comparative Examples 1-3, though having comparable TVOC value, cannot pass spray processing.

b. Polyurethane Foam with a Lower Density

The inventors conducted another experiment to obtain polyurethane foam with a lower density. All the procedures are repeated according to example 1 except that the amount of each component was altered as shown in the following Table 2.

TABLE 2

| Example | Inventive example 4 |
|---|---|
| ISOCYANATE B1001 | 120 |
| Polyether polyol, LUPRANOL 2095 | 10 |
| Polyester polyol, LUPRAPHEN 3905 | 9.2 |
| Solid flame retardant, expandable | 15 |
| graphite | |
| Solid flame retardant, melamine | 30 |
| Liquid flame retardant, TCPP | 12 |
| Surfactant, ORTEGOL 501 | 0.3 |
| Surfactant, TEGOSTAB ® B 1048 | 1.0 |
| Catalyst, JEFFCAT ZF10 | 2.5 |
| Blowing agent,water | 8 |
| Chain extender, Dipropylene glycol | 12 |
| Foam density (kg/m³) | 16 |
| LOI (%) | 28.2 |
| Flammability | A-0 |
| TVOC (μgC/g) | 206 |
| Volume percentage of closed cells (%) | <10 |
| Spray processing | Pass |

It can be seen from the Table 2 that, Inventive example 4 shows successful spray processing and at the same time foam density as low as 16 kg/m³. It is generally recognized in the art that polyurethane foam with higher density usually shows better flame resistance. Surprisingly, the foam according to the invention shows excellent flame resistance at a density as low as 16 kg/m³.

The structures, materials, compositions, and methods described herein are intended to be representative examples of the invention, and it will be understood that the scope of the invention is not limited by the scope of the examples. Those skilled in the art will recognize that the invention may be practiced with variations on the disclosed structures, materials, compositions, and methods, and such variations are regarded as within the ambit of the invention. Thus, it is intended that the present invention cover such modifications and variations as come within the scope of the appended claims and their equivalents.

1. A flame-retardant polyurethane spray foam system, comprising
an isocyanate component consisting of
a) at least one isocyanate, and
resin components consisting of
b) at least one substance reactive toward isocyanate,
c) optionally a chain extender and/or crosslinking agent,
d) a flame retardant,
e) a blowing agent,
f) catalysts, and optionally
g) additives and/or auxiliaries,
wherein the flame retardant (d) comprises expandable graphite and melamine, the amount of expandable graphite is in the range of from 5 wt % to less than 30 wt %, and the amount of melamine is in the range of from greater than 5 wt % to 30 wt %, each based on the total weight of the resin components.

2. The polyurethane spray foam system according to claim 1, wherein the amount of expandable graphite is in the range of 10 to 25 wt %, based on the total weight of the resin components.

3. The polyurethane spray foam system according to claim 1, wherein the amount of melamine is in the range of 10 to 25 wt %, based on the total weight of the resin components.

4. The polyurethane spray foam system according to claim 1, wherein the total amount of expandable graphite and melamine is in the range of 10 to 40 wt %, based on the total weight of the resin components.

5. The polyurethane spray foam system according to claim 1, wherein the flame retardant (d) further comprises at least one phosphorus-containing flame retardant which is a derivative of phosphoric acid, phosphonic acid, and/or phosphinic acid.

6. The polyurethane spray foam system according to claim 5, wherein the amount of said phosphorus-containing flame retardant is in the range of 10 to 40 wt %, based on the total weight of the resin components.

7. The polyurethane spray foam system according to claim 1, wherein the weight ratio of resin components and isocyanate component is in a range of from 1:0.8 to 1:1.2.

8. The polyurethane spray foam system according to claim 1, wherein the spray foam system is used for producing polyurethane foam with a density between 10 and 40 kg/m³.

9. The polyurethane spray foam system according to claim 1, wherein isocyanate (a) is selected from the group consisting of aliphatic, cycloaliphatic, araliphatic and/or aromatic isocyanates, tri-, tetra-, penta-, hexa-, hepta- and/or octamethylene diisocyanate, 2-methylpentamethylene 1,5-diisocyanate, 2-ethylbutylene 1,4-diisocyanate, pentamethylene 1,5-diisocyanate, butylene 1,4-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), cyclohexane 1,4-diisocyanate, 1-methylcyclohexane 2,4- and/or 2,6-diisocyanate and/or dicyclohexylmethane 4,4′-, 2,4′- and 2,2′-diisocyanate, diphenylmethane 2,2′-, 2,4′- and/or 4,4′-diisocyanate (MDI), polymeric MDI, naphthylene 1,5-diisocyanate (NDI), tolylene 2,4- and/or 2,6-diisocyanate (TDI), 3,3′-dimethyl diphenyl diisocyanate, 1,2-diphenylethane diisocyanate and phenyl ene diisocyanate.

10. The polyurethane spray foam system according to claim 1, wherein the component (b) is selected from the group consisting of polyether polyols, polyester polyols and mixtures thereof.

11. The polyurethane spray foam system according to claim 1, wherein the component (c) is selected from the group consisting of aliphatic, araliphatic, aromatic, and/or cycloaliphatic difunctional compounds.

12. The polyurethane spray foam system according to claim 1, wherein the blowing agent (e) is water.

13. The polyurethane spray foam system according to claim 1, wherein the catalyst (f) is selected from the group consisting of amine-based catalysts.

14. The polyurethane spray foam system according to claim 1, wherein the component (g) comprises organosilicone surfactant.

15. The polyurethane spray foam system according to claim 1, which comprises, each based on the total weight of resin components (b)-(g),
a) 100-120 wt % of at least one isocyanate,
b) 0-40 wt % of at least one substance reactive toward isocyanate,
c) 0-20 wt % of optional chain extender and/or crosslinking agent,
d) 25-45 wt % of flame retardant,
e) 2-15 wt % of blowing agent,
f) 1-5 wt % of catalyst, and optionally
g) 0-2 wt % of additives and/or auxiliaries,
wherein the flame retardant (d) comprises expandable graphite and melamine, the amount of expandable graphite is in the range of 10 to 25 wt %, and the amount of melamine is in the range of 10 to 25 wt %, each based on the total weight of the resin components.

16. A method for the production of flame-retardant polyurethane foam from the polyurethane spray foam system according to claim 1, comprising the following steps:
providing resin components blend comprising components (b)-(g);
providing isocyanate component (a); and
reacting resin components blend and isocyanate in a weight ratio of 1:0.8 to 1:1.2.

17. A method according to claim 16, wherein the step of reacting resin components blend and isocyanate is defined as spraying resin components blend and isocyanate.

18. A method according to claim 17, wherein the step of spraying resin components blend and isocyanate is defined as mixing them through a nozzle of a spray gun.

19. A flame-retardant polyurethane foam produced according to claim 16.

20. The polyurethane foam according to claim 19, wherein the foam has a LOI value of at least 26%, measured according to GB/T 2406.2-2009.

21. The polyurethane foam according to claim 19, wherein the foam has TVOC of at most 220 μgC/g, measured according to VDA 277.

22. The polyurethane foam according to claim 19, wherein the foam has a density between 10 and 40 kg/m³.

23. A method of using the flame-retardant polyurethane foam according to claim 19, the method comprising using the flame-retardant polyurethane foam for heat insulation, sound insulation, or in cavity filling (sponge) and damping packing foam applications.
